(19) United States
(12) Patent Application Publication
(10) Pub. No.: US 2005/0051002 A1
(43) Pub. Date: Mar. 10, 2005

(54) Sealed powered ratchet wrench

(76) Inventor: Kevin Brun, Berkeley, CA (US)

Correspondence Address: Harris Zimmerman;Law Offices of Harris Zimmerman, Suite 710, 1330 Broadway, Oakland, CA, 94612-2506, US

(21) Appl. No.: 10/935,797

(22) Filed: Sep. 7, 2004

Related U.S. Application Data
(60) Provisional application No. 60/500,380, filed on Sep. 5, 2003.

(51) Int. Cl. B25B 13/46

(52) U.S. Cl. 81/57.39

(57) ABSTRACT

A motor driven ratchet wrench has a ratchet gear, oscillating pawl and pawl driver components situated in a sealed housing at the head end of the wrench. Premature wearing of parts is avoided as dirt cannot enter and lubricant does not escape. Frequent cleaning and relubrication is unnecessary. Internal components of the pawl, pawl driver and directional control for reversing the angular direction of the torque which is applied to threaded fasteners have configurations which enable the head end of the sealed wrench to be compact as is advantageous for use of the wrench is constricted locations.

### CROSS-REFERENCE TO RELATED APPLICATION

This application claims subject matter disclosed in U.S. Provisional Application No. 60/500,380 entitled “Power Ratchet Head” and which was filed on Sep. 5, 2003 by Kevin Brun.

### STATEMENT REGARDING FEDERALLY SPONSORED RESEARCH OR DEVELOPMENT (Not Applicable)

### BACKGROUND OF THE INVENTION

This invention relates to ratchet wrenches for tightening and loosening nuts, bolts or other threaded fasteners. More particularly, the invention relates to ratchet wrenches which have pawl and ratchet means for applying a repetitive torque force to threaded fasteners in response to rotation of a motor driven crankshaft.

Powered ratchet wrenches greatly facilitate automotive repair work, manufacturing procedures and various other operations where threaded fasteners must be engaged or disengaged. Among other advantages, the operator of the wrench need not exert the sizable force that may be needed to tighten or loosen a threaded fastener. The powered wrench may be used in constricted spaces where it may not be practical to pivot a wrench manually in order to engage or disengage the fastener.

Powered ratchet wrenches greatly facilitate automotive repair work, manufacturing procedures and various other operations where threaded fasteners must be engaged or disengaged. Among other advantages, the operator of the wrench need not exert the sizable force that may be needed to tighten or loosen a threaded fastener. The powered wrench may be used in constricted spaces where it may not be practical to pivot a wrench manually in order to engage or disengage the fastener.

Powered ratchet wrenches have a ratchet gear which is rotated through repetitive angular increments by pawl mechanism that oscillates in response to continuous turning of a crankshaft. The crankshaft is driven by a pneumatic or electrical motor. Many wrenches also have internal components which enable selectively reversing of the direction of rotation of the ratchet gear. In prior wrench designs some or all of these mechanisms are exposed to the external environment through various openings at the head end of the wrench. Dirt and other foreign materials can enter and contaminate the mechanism. Lubricant is free to escape. Consequently, frequent maintenance operations have been needed to clean and lubricate the mechanism and thereby avoid premature wearing of the wrench. This is a time consuming inconvenience.

The mechanism at the head end of a powered ratchet wrench should be compact in order to permit entry of the end of the wrench into constricted spaces. This complicates efforts to provide mechanism which is not subject to the problem discussed above.

The present invention is directed to overcoming one or more of the problems discussed above.

### BRIEF SUMMARY OF THE INVENTION

In one aspect the present invention provides a motor driven ratchet wrench having a head end housing attached to a handle and a ratchet gear situated at a first opening in the housing. The wrench further including output means for applying torque to external threaded fasteners in response to rotation of the ratchet gear, a crankshaft extending through a second opening in the housing and pawl and pawl driver means in the housing for rotating the ratchet gear in repetitive increments in response to continuous rotation of the crankshaft. A plurality of seals includes seals disposed at each opening in the housing thereby blocking entry of external substances into the housing and thereby retaining lubricant in the housing.

The invention provides a powered ratchet wrench in which moving parts at the head end of the wrench are situated in a sealed housing. This prevents entry of dirt or other materials and assures retention of lubricant. Wearing of components of the wrench is greatly reduced without requiring frequent cleaning a lubrication of the tool. The invention provides pawl mechanism and pawl driver mechanism which can be contained in the sealed housing without requiring any unsealed openings in the housing.

The invention, together with further objects and advantages thereof, may be further understood by reference to the following detailed description of the preferred embodiments and by reference to the accompanying drawings.

### BRIEF DESCRIPTION OF THE SEVERAL VIEWS OF THE DRAWINGS

In the accompanying drawings:

FIG. 1 is a perspective view of a motor driven ratchet wrench, embodying the invention, as viewed from the back of the tool.

FIG. 2 is a perspective view of the head end portion of the wrench of FIG. 1 shown disengaged from the other portions of the tool.

FIG. 3 is a perspective view of the head end portion of the wrench of FIG. 1 as viewed from the front of the tool.

FIG. 4 is a broken out section view of the handle, motor and gear housing portion of the wrench of the preceding figures.

FIG. 5 is a longitudinal section view of the head end portion of the wrench of the preceding figures.

FIG. 6 is an exploded perspective view of the head end portion of the wrench of the preceding figures as viewed from the back of the tool.

FIG. 7 is an exploded perspective view of a ratchet gear and gear driving mechanism which appears in assembled form in FIG. 6.

FIG. 8 is an exploded perspective view of the head end portion of the wrench of the preceding figures and is similar to FIG. 6 except that the apparatus is shown as viewed from the front of the tool.

FIG. 9 is an exploded perspective view of the ratchet gear and gear driving mechanism of FIG. 7 as viewed from the front of the tool.

FIG. 10 is a perspective view of a portion of the head end of the ratchet wrench of the preceding figures in which a directional control is shown separated from the housing for purposes of illustration.

FIG. 11 is an exploded perspective view of the directional control of FIG. 10.

FIG. 12 is a diagrammatic view depicting the installation of the directional control of FIG. 10 into the head end housing of the ratchet wrench.

FIG. 13 is a broken out view of the back of the head end housing of the wrench of the preceding figures in which the directional control is shown prior to installation of the shift lever assembly in the head end housing.

FIG. 14 shows the structure of FIG. 13 with the directional control installed in the head end housing.

FIG. 15 is a side view of a ratchet lever assembly component of the apparatus of the preceding figures.

FIG. 16 is a view of the back face of the ratchet lever assembly of FIG. 15

FIG. 17 is an exploded perspective view of the ratchet lever assembly of FIGS. 15 and 16.

FIGS. 18 to 21 are sectional views of the head end of the wrench of the preceding figures as viewed from the back of the wrench and depicting successive stages in the operation of the pawl and ratchet mechanism.

FIGS. 22 to 25 are broken out views of the head end of the wrench of the preceding figures as viewed from the front of the wrench and depicting successive stages in the operation of the directional control mechanism.

FIG. 26 is a longitudinal section view of the head end of a second embodiment of the invention which has a modified form of directional control for selecting the angular direction of the rotary force that is applied to threaded fasteners.

FIG. 27 is an exploded perspective view of the directional control of FIG. 26.

FIGS. 28, 29 and 30 are broken out front views of the apparatus of FIG. 26 illustrating successive stages in the operation of the modified directional control.

FIG. 31 is a perspective view of a ratchet gear and ratchet lever assembly of a third embodiment of the invention as viewed from the back of the assembly.

FIG. 32 is an exploded perspective view of the ratchet gear and ratchet lever assembly of FIG. 31.

FIG. 33 is a perspective view of the ratchet gear and ratchet lever assembly of FIG. 31 as viewed from the front of the assembly.

FIG. 34 is an exploded perspective view of the ratchet gear and ratchet lever assembly of FIG. 33.

FIG. 35 is a frontal view of the ratchet gear and ratchet lever assembly of FIGS. 31 to 34.

FIG. 36 is a side view of the ratchet gear and ratchet lever assembly of FIG. 35.

FIG. 37 is a broken out perspective view of ratchet lever and pawl components of the ratchet gear and ratchet lever assembly of FIGS. 31 to 36.

FIG. 38 is an exploded perspective view of a directional control component of the ratchet gear and ratchet lever assembly of FIGS. 31 to 36.

FIG. 39 is a longitudinal section view of the head end region of the third embodiment of the invention.

FIGS. 40 to 44 are broken out views of the head end region of the third embodiment of the invention depicting successive stages in the operation of the apparatus.

FIG. 45 is a front view of the ratchet lever assembly of a fourth embodiment of the invention.

FIG. 46 is a side view of the ratchet lever assembly of FIG. 45

FIG. 47 is an exploded perspective view of the directional control component of the fourth embodiment.

FIGS. 48 to 50 are broken out front views of the head end region of the fourth embodiment illustrating stages in the operation of the apparatus.

FIG. 51 is a perspective view of the ratchet lever assembly of a fifth embodiment of the invention as viewed from behind the assembly.

FIG. 52 is an exploded view of the apparatus of FIG. 51.

FIG. 53 is a perspective view of the ratchet lever assembly of FIGS. 51 and 52 as viewed from the front of the assembly.

FIG. 54 is an exploded perspective view of the apparatus of FIG. 53.

FIG. 55 is a front view of the ratchet lever assembly of FIGS. 51 to 53.

FIG. 56 is a side view of the ratchet lever assembly of FIGS. 51 to 55.

FIG. 57 is a broken out perspective view depicting components of the ratchet lever assembly of a fifth embodiment of the invention.

FIG. 58 is an exploded perspective view of a directional control component of the fifth embodiment of the invention.

FIG. 59 is a broken out front view of the head end region of the fifth embodiment of the invention.

FIG. 60 is a broken out perspective view of the head end region of the fifth embodiment of the invention as viewed at the back of the apparatus.

FIG. 61 is a section view of the head end region of the fifth embodiment of the invention taken along the central plane of the apparatus.

FIGS. 62 to 65 are broken out front views of the head end region of the fifth embodiment of the invention illustrating successive stages in the operation of the mechanism.

FIG. 66 is a broken out perspective view of components of a sixth embodiment of the invention which has a modified form of directional control for selecting the angular direction of the rotary force that is applied to threaded fasteners.

FIG. 67 is an exploded perspective view of a shift lever assembly of the sixth embodiment of the invention.

FIG. 68 is a longitudinal section view of the head end of the sixth embodiment of the invention.

FIGS. 69 to 72 are broken out front views of the head end region of the sixth embodiment illustrating successive stages in the operation of the apparatus.

FIG. 73 is a perspective view of a another embodiment of the invention having a head end assembly which is interchangeable with differing head end assemblies and which can operate with different forms of electrical power supply.

FIG. 74 is a perspective view of the embodiment of FIG. 73 showing the interchangeable head end assembly removed from the tool and showing an alternate form of connection to an electrical power supply.

FIG. 75 is a perspective view of the interchangeable head end assembly of FIGS. 73 and 74 as viewed from the front of the assembly.

FIG. 76 is a broken out side view of a central portion of the tool of FIGS. 73 to 75.

FIG. 77 is a longitudinal section view of the interchangeable head end assembly of the tool depicted in FIGS. 73 to 76.

FIG. 78 is a longitudinal section view of another interchangeable head end assembly for the tool depicted in FIGS. 73 to 76 which head end assembly has an angled configuration.

FIG. 79 is an exploded perspective view of still another interchangeable head end assembly for the tool depicted in FIGS. 73 to 76 which head end assembly an output member of the box end socket type.

FIG. 80 is an exploded perspective view of a component of the interchangeable head end assembly of FIG. 79 which includes a box end socket, ratchet gear, pawl and pawl operating mechanism.

FIG. 81 is an exploded perspective view of the interchangeable head end assembly of FIGS. 79 and 80 as viewed from the back of the assembly.

FIG. 82 is an exploded perspective view of a directional control component of the interchangeable head end assembly of FIGS. 79, 80 and 81.

FIG. 83 is a top view of a component of the interchangeable head end assembly of FIGS. 79 to 82 which includes a ratchet gear, pawl and pawl operating mechanism.

FIGS. 84 and 85 illustrate successive stages in the operation of the interchangeable head end assembly of FIGS. 79 to 83.

FIG. 86 is a perspective view of a modified ratchet lever component for the previously described embodiments in which the component has a two piece construction.

FIG. 87 is an exploded perspective view of the modified component of FIG. 86.

FIG. 88 is an exploded perspective view of an alternate construction for a ratchet gear and output member assembly for the previously described embodiments.

FIG. 89 is a perspective view showing the structure of FIG. 88 in assembled form.

FIG. 90 is a perspective view of an alternate construction for a head end housing component of the previously described embodiments in which the housing has a three piece construction, the apparatus being viewed from the back of the housing.

FIG. 91 is a perspective view of the head end housing of FIG. 90 as viewed from the front of the housing.

FIG. 92 is an exploded perspective view of the head end housing of FIGS. 90 and 91.

FIG. 93 is a longitudinal section view of the apparatus of FIG. 90.

### DETAILED DESCRIPTION OF THE INVENTION

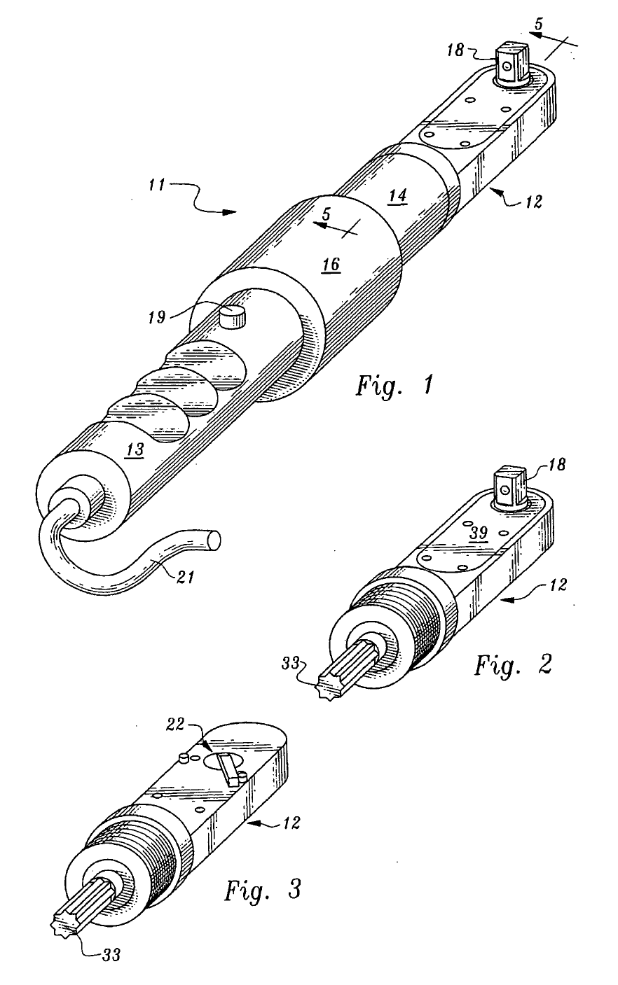

Referring initially to FIGS. 1 to 3 of the drawings, externally visible features of the motor driven ratchet wrench 11 of this example of the invention include a sealed head end housing 12 which is attached to a handle 13 through a gearing housing 14 and a motor housing 16. In this example, the means 17 for applying torque to threaded fasteners which are to be loosened or tightened is a square drive of the known form which is of square cross section at its outer end and on which standardized sockets of known form and differing sizes can be snap engaged. An on/off control 19 is situated on the underside of handle 13. Control 19 is a manually operable electrical switch as the wrench 11 of this example has an electrical drive motor. Alternately, the wrench 11 may have a pneumatic drive motor in which case control 19 is a manually operable valve. A flexible electrical cord 21 extends from the end of handle 13 for connection to a source of electrical power. Alternately, a battery for powering the wrench 11 can be contained within handle 13. Cord 21 is replaced with a flexible air conduit if the wrench 11 is powered by a pneumatic motor.

A directional control 22 provides a manually operable means which enables the operator to select the angular direction of the force which the wrench 11 applies to a threaded fastener. Prior ratchet wrenches in which the directional control is attached to moving internal parts of the ratchet mechanism require an opening in the head end housing that is larger than the control itself in order to accommodate to the motion of the directional control. Sealing of the head end of the wrench 11 is facilitated in the present invention as the shift lever assembly 22 is seated in a conforming opening 23 the head end housing 12 rather than being carried by a moving part of mechanism which is within the housing. Thus the opening 23 need not be larger than diameter of the assembly 22 itself and can be provided with a seal as will hereinafter be described. Other aspects of the directional control 22 will also hereinafter be described.

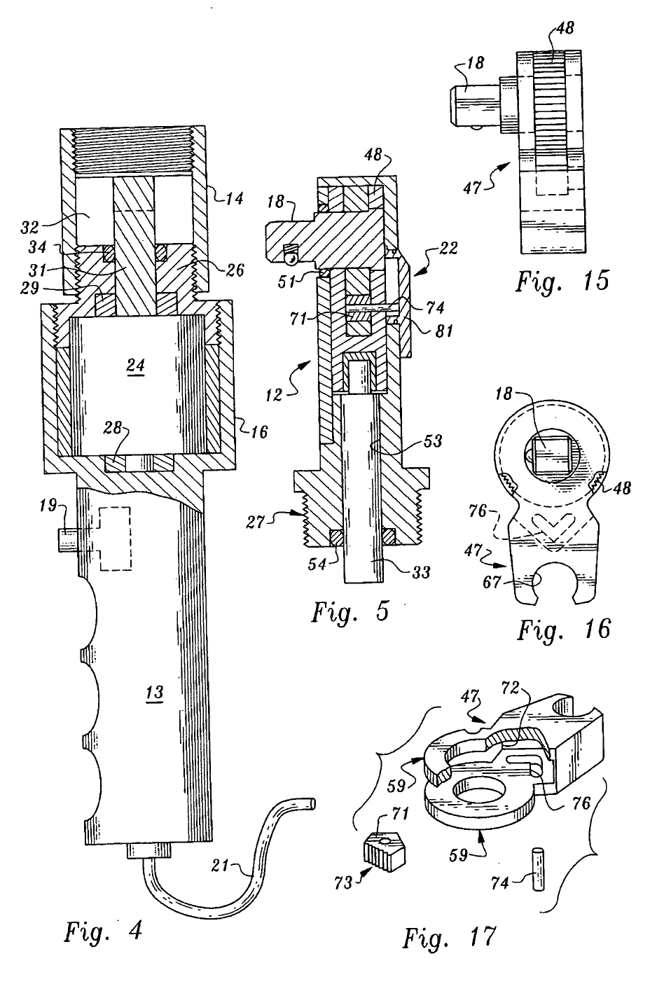

Referring jointly to FIGS. 4 and 5, drive motor 24 is disposed within motor housing 16 which may be an integral cylindrical extension of handle 13. The front end of motor housing 16 is closed by a stepped annular coupler member 26 which is in threaded engagement with the motor housing. Gear housing 14 is a sleeve having a threaded back end engaged with the coupler member 26 and a threaded forward end which is engaged with a threaded connector portion 27 of the head end housing 12 of the wrench 11.

Bearings 28 and 29, seated in motor housing 16 and coupler member 26, journal the rotor shaft 31 of motor 24. Shaft 31 extends forward to deliver rotary drive to planetary gearing 32 situated in gear housing 14. Planetary gearing 32 functions in the known manner to effect a speed reduction accompanied by an amplification of torque force. A rotary crankshaft 33 extends forward from gearing 32 to transmit drive to mechanism in head end housing 12 which will hereinafter be described. An annular seal 34, seated in coupler member 26, encircles rotor shaft 31. Seal 34 prevents loss of lubricant from the planetary gearing 32.

The internal constructions of the motor 24 and planetary gearing 32 may be of the conventional designs well understood by those skilled in the art.

Referring to FIGS. 5, 6 and 7, head end housing 12 forms a sealed chamber 36 defined by a back wall 37, sidewall 38 which is of semicircular shape at the forward end and a cover plate 39. Cover plate 39 seats on a rear shelf 41 at the back of chamber 36 and two side shelves 42 at opposite sides of the chamber. Shelves 41 and 42 may be integrally formed portions of the head end housing 12. Threaded bolts 43 engage in bores in shelves 41 and 42 to secure the cover plate 39 in place. Entry of foreign material into chamber 36 and loss of lubricant at the perimeter of cover plate 39 is prevented by another seal 44 which extends around the periphery of the cover plate and which is seated in a peripheral groove 46 in the side of the cover plate.

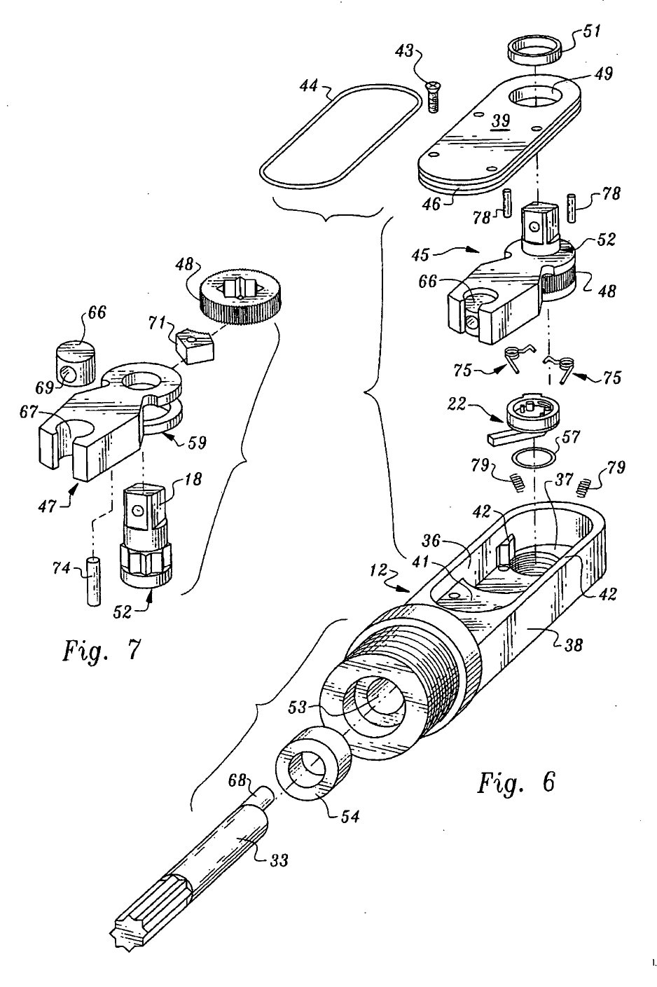

Referring to FIGS. 6, 7, 8 and 9, a ratchet lever 47 is disposed in chamber 36 and contains a ratchet gear 48. Square drive member 18 is seated in ratchet gear 48 in centered relationship therewith and extends out of the head end housing 27 through a circular opening 49 in cover plate 39. An annular seal 51 encircles a circular shank 52 portion of square drive member 18, within opening 49, to prevent entry of foreign material and to retain lubricant in chamber 36.

The previously described crankshaft 33 extends into chamber 36 through an axially directed bore 53 in the connector portion 27 of the head end housing 12. Referring again to FIGS. 4 and 5, another annular seal 54 is seated in connector portion 27 of the housing 12 and encircles the crankshaft 33 to isolate lubricant in chamber 36 from the lubricant in planetary gearing 32 in instances where different lubricants are present. For example, the planetary gearing 32 may contain oil while components in chamber 36 are lubricated with grease. The passage leading to chamber 36 which extends along motor shaft 31 and crankshaft 33 is also sealed by the previously described seal 34. Thus seal 54 is not needed in instances where the same lubricant is used in the planetary gearing 32 and in chamber 36.

Referring to FIGS. 3, 10 and 11, directional control 22 has a cylindrical cap 56 which is seated in the opening 23 at the front face of head end housing 12. A circular seal 57 is seated in a groove 58 that extends around the periphery of cap 56 thereby sealing chamber 36 at opening 23.

The above described seals 44, 51, 54 and 57 collectively seal all opening in the walls of the chamber 36 of the head end housing 12. Ratchet lever 47 has a configuration which enables the lever and associated moving components to be wholly enclosed in the sealed chamber 36.

In this example, with reference to FIGS. 6, 7, 15, 16 and 17, the head end of the ratchet lever 47 has spaced apart coaxial ring portions 59 which are centered on the rotary axis of square drive 18 with the ratchet gear 48 being disposed between the ring portions in coaxial relationship with the ring portions. The circular curvature of the adjacent sidewall 38 of head end housing 12 and a similar curvature of the adjacent walls of shelves 42 prevent movement of the ring portions 59 other than rotational movement. Square drive 18 extends through the central openings 61 of the ring portions 59 and out of chamber 36 through the previously described opening 49 and seal 51. External splines 62 on square drive 18 engage internal splines 63 of ratchet gear 48 to cause the square drive to rotate with the gear.

An arm 64 of the ratchet lever 47 extends from the ring portions 59 towards crankshaft 33. Referring to FIGS. 5, 6 and 7, a coupler cylinder 66 is situated in a conforming cylindrical cavity 67 in the end of arm 64. A crankpin 68 at the end of crankshaft 33 extends into an opening 69 in the coupler cylinder 66. Crankpin 68 extends in parallel relationship with the rotary axis of crankshaft 33 but is offset from that axis. Consequently, the motor driven rotation of the crankshaft 33 causes a repetitive limited angular oscillation or pivoting movement of the ratchet lever 47 about the axis of ratchet gear 48.

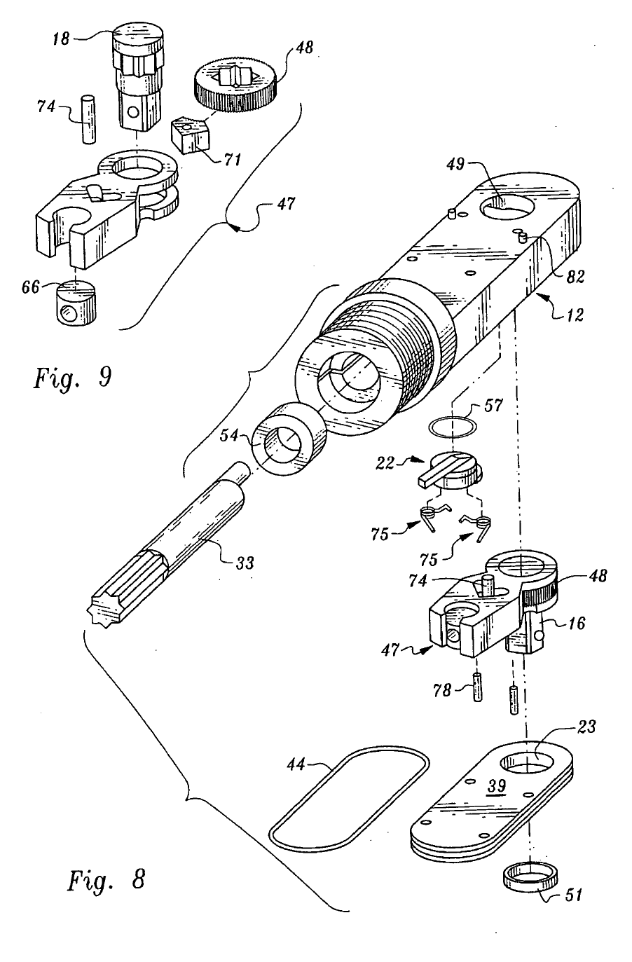

Referring to FIGS. 5, 15, 16 and 17, a slidable pawl 71 is carried by the ratchet lever 47 and causes repetitive turning of the ratchet gear 48 in a single direction in response to the angular oscillation of the ratchet lever 47. Pawl 71 is disposed in a compartment 72 in the ratchet lever 47 which extends towards ratchet gear 48. Pawl 71 has gear teeth 73 which intermittently engage the teeth of the ratchet gear 48 as will hereinafter be further described. A pin 74 extends from the pawl into a right angled guide slot 76 in the adjacent walls of compartment 72. Referring again to FIG. 8, pawl biasing springs 75 in the directional control 22 exert spring forces on pin 74 which urge the pin towards one end of slot 76 when the control is set too cause clockwise rotation of the ratchet gear 48 and which urge the pin towards the opposite end of slot when the control is set to cause counter-clockwise rotation. The directional control 22 including pawl biasing springs 75 will hereinafter be further described.

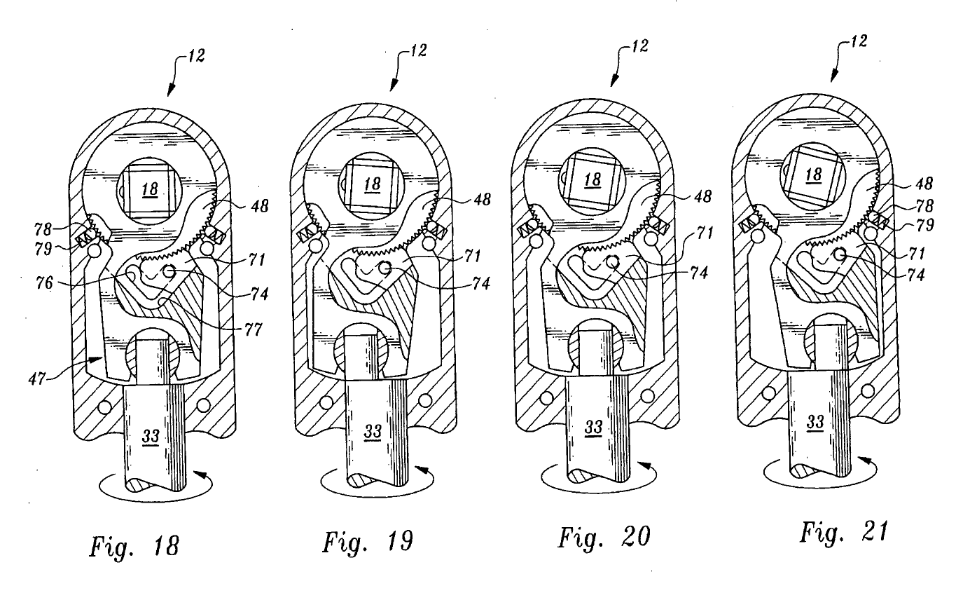

Operation of the pawl 71 and further structural detail of the mechanism will best be understood by reference to FIGS. 18 to 21 which show successive stages in a power stroke and a return stroke of ratchet lever 47. At the beginning of the power stroke depicted in FIG. 18, pawl 71 is being urged to the position shown in the figure by the pawl biasing springs 75. At this position the pawl 71 is forced into engagement with ratchet gear 48 as it is wedged between the gear and an adjacent obliquely angled wall 77 of compartment 72. Thus the following pivoting motion of ratchet lever 47 forces ratchet gear 48 to rotate an incremental amount. At the end of the power stroke as shown in FIG. 19, lateral travel of crankpin 68 reverses and the ratchet lever 47 begins to pivot in an opposite direction. This allows pawl 71 to retract from the ratchet gear 48 as shown in FIG. 20 as it the reversed motion of the oblique wall 77 does not act to wedge the pawl against the gear. Any drag force which the pawl 71 might exert on gear 48 at this stage is resisted by detent rods 78 which are urged against the teeth of the gear by coil springs 79. At the end of the return stroke as shown in FIG. 21, pivoting movement of ratchet lever 47 reverses again causing reengagement of pawl 71 with gear 48 and a repetition of the cycle of operation described above. Consequently, gear 48 and thus square drive 18 is rotated in a single angular direction in a continuing series of intermittent movements.

If the operator shifts the directional control to the alternate setting, biasing spring force urges pin 74 and thus pawl 71 towards the opposite end of angled guide slot 76. Operation then proceeds essentially as described above except that the pattern of pawl 71 movement is reversed and ratchet gear 48 and square drive 18 are turned in an opposite rotational direction.

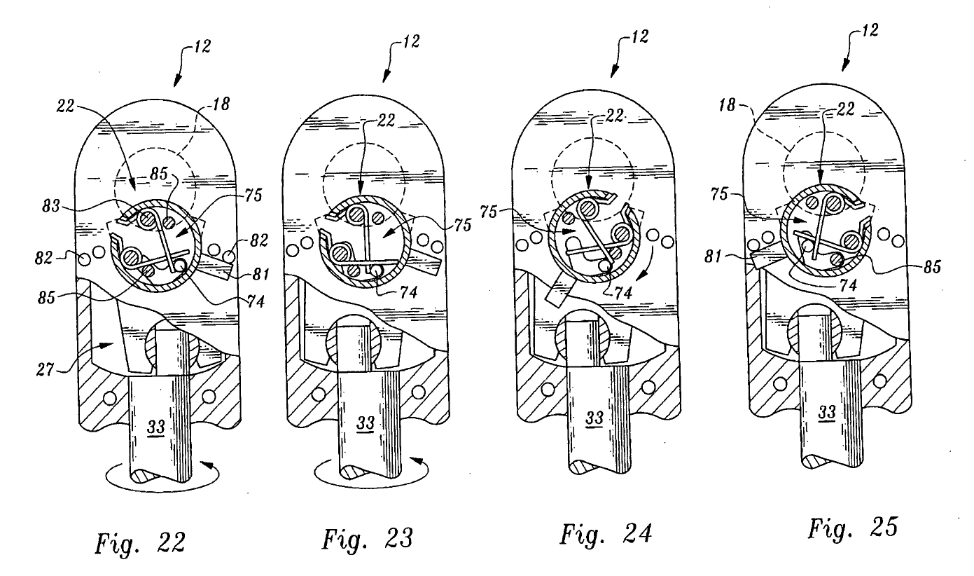

The directional control 22 at different stages of operation is depicted in FIGS. 22 to 25. Cap 56 of the directional control has a radial extending lever 81, situated outside of head end housing 12, which the operator may turn to the orientation shown in FIGS. 22 and 23 in order to select rotation of the square drive 18 in a first angular direction. Turning of lever 81 to the orientation shown in FIGS. 24 and 25 reverses the angular motion of square drive 18. Protrusions 82 on the outside surface of head end housing 12 demark the range of turning of lever 81 between the two positions described above. Referring to FIGS. 22 and 11 in conjunction, the pawl biasing springs 75 are angled wire springs attached to pedestal supports 83 within cap 56. Each spring 75 is positioned to urge pawl pin 74 in an opposite direction. A first of the springs 75 acts on the pawl pin 74 when lever 81 of the directional control is oriented as shown in FIGS. 22 and 23. This positions the pawl 71 at one side of guide slot 76 as has been described with reference to FIGS. 18 to 21. The other spring 75 acts on the pawl pin 74 when lever 81 is turned to its other position as shown in FIGS. 24 and 25. This positions the pawl 71 at the other side of guide slot 76 to reverse the rotation of square drive 18 in the manner previously described. Stops 85 in caps 56 are positioned to prevent both springs 75 from acting on pawl pin 74 at the same time.

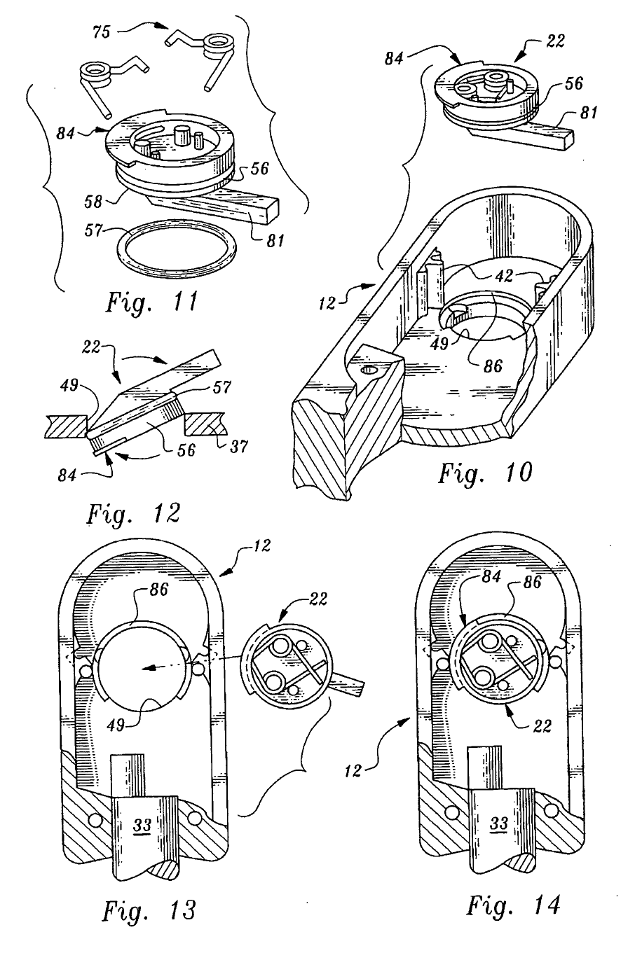

Referring jointly to FIGS. 10, 12 and 14, an arcuate lip 84 extends outward from the base of cap 56 of directional control 22 at the portion of the cap that is opposite from lever 81. Lip 84 fits into a conforming arcuate groove 86 which partially encircles opening 49 at the base of the opening in order to retain directional control 22 in place. Groove 86 is longer than lip 84 by an amount sufficient to enable the above described turning of cap 56 between the two settings of the control. As shown in FIG. 10, the directional control 22 assembly can be fitted into place at opening 49 by tilting the control as it is being inserted into the opening.

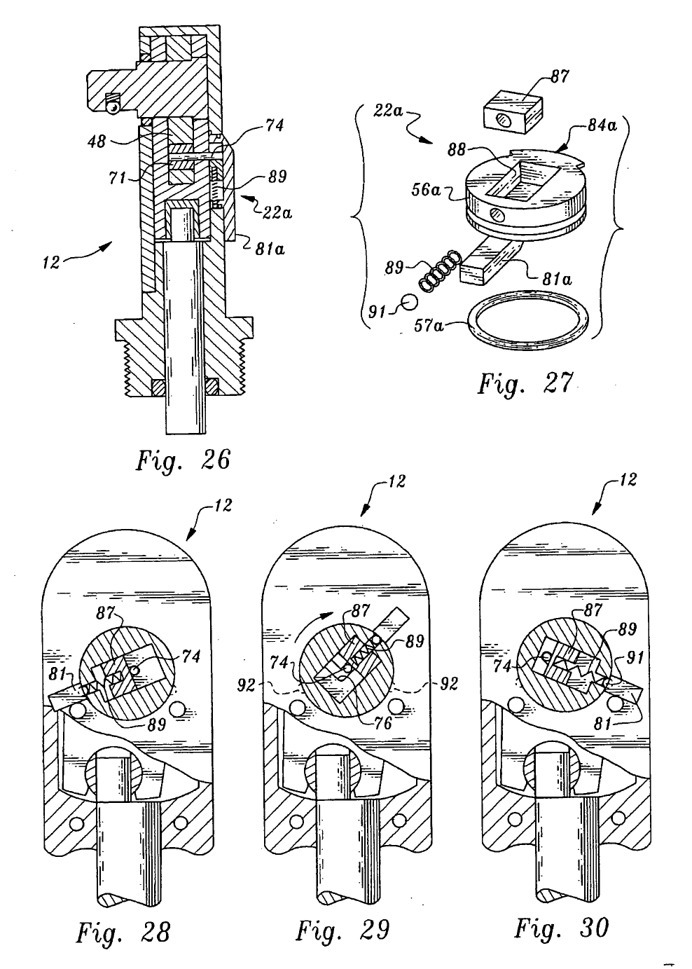

As has been described with reference to FIGS. 22 to 25, the direction in which the ratchet gear 48 is turned depends on the direction of the spring force which is applied to the pawl pin 74. Manual pivoting of the directional control 22 reverses this spring force. FIGS. 26 to 30 depict a second embodiment of the directional control 22a which has a different internal construction but accomplishes the same result of applying a selectively reversible spring force to pawl pin 74.

Referring to FIGS. 26 and 27, directional control 22a has a cylindrical cap 56a encircled by an annular seal 57a and having a radially directed lever 81a and a retainer lip 84a which are similar to the previously described portions of the first embodiment. Cap 56a contains a rectangular plunger 87 which is slidable in a rectangular slot 88 formed in the cap. One end of a compression spring 89 urges plunger 87 against pawl pin 74 and the other end of the spring acts against a detent ball 91. Plunger 87 and slot 88 are oriented to cause the spring force to urge pawl pin 74 towards one end of the angled pin guide slot 76 when lever 81a is turned to the first setting shown in FIG. 28. The spring 89 is compressed, as shown in FIG. 29, while lever 81a is being moved away from the first setting as pawl pin 74 can only move along the guide slot 76. When lever 81a reaches its second setting as shown FIG. 30 the spring 89 is able to extend and urge the pawl pin 74 towards the other end of the angled guide slot 76 thereby reversing the rotational direction of the ratchet gear in the manner previously described. Spring 89 urges detent ball 91 into a pocket 92 in the wall of opening 49 when the lever 81a is at either of its two settings to create a force which tends to resist movement of the lever away from the selected setting.

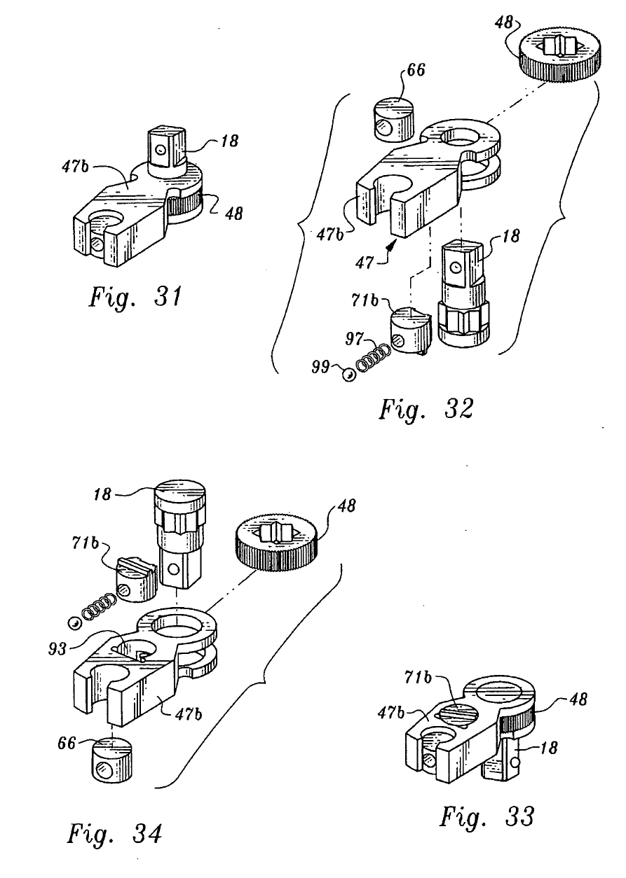

The pawl 71 of the previously described embodiments of the invention may be described as a sliding bi-directional pawl as it is shifted in a lateral direction to reverse the rotation of the output of the wrench. FIGS. 31 to 34 depict a third embodiment of the invention having what may be termed a pivoting bi-directional pawl 71b. Referring initially to FIGS. 31 to 34 in particular, the ratchet lever 47b is similar to the corresponding component of the previously described embodiments except that it has a circular chamber 93 in which the pawl 71b is disposed. Ratchet gear 48 and square drive 18 are similar to the corresponding components of the previously described embodiments. Directional control; has a modified configuration which will hereinafter be described.

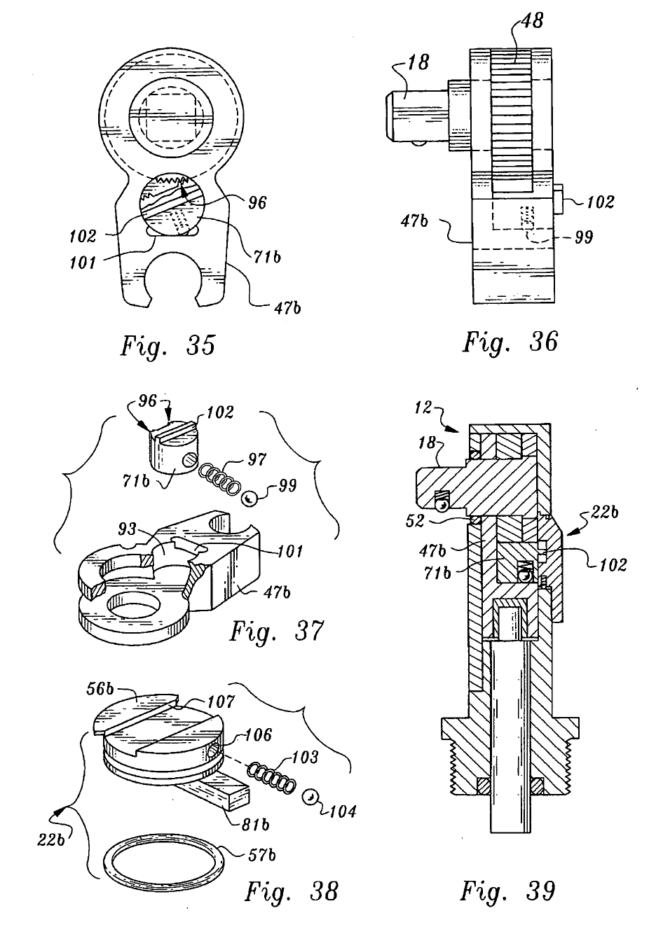

Referring jointly to FIGS. 35 to 39, pawl 71b is cylindrical and conforms in shape with chamber 93 except that two spaced apart bands of gear teeth 96 extends along the portion of the surface of the pawl that faces ratchet gear 48. The pawl 71b may be rotated within chamber 93 to bring either band of gear teeth 96 into position for engaging the ratchet gear 48. A compression spring 97 is disposed in a radial bore 98 in pawl 71b and acts against a detent ball 99 situated at the outer end of the bore. Bore 98, spring 97 and ball 99 are positioned to enable travel of the ball along a detent guide slot 101 which is recessed in the wall of chamber 93. Slot 101 limits rotation of pawl 71b to an orientation at which a first of the bands of gear teeth 96 is positioned to engage ratchet gear 48 and a second orientation at which the other of the bands of gear teeth is positioned to engage the gear 48. A linear rib 102 extends across the front surface of pawl 71b to enable manual turning of the pawl as will hereinafter be further described.

The directional control 22b of this embodiment has a modified cylindrical cap 56b with a radial extending lever 81b and, together with an annular seal 57b, is seated in opening 49 of the head end housing in the same manner as the corresponding component of the previously described embodiments. Another compression spring 103 and detent ball 104 are seated in a radial bore 106 in cap 56b. A linear channel 107 extends diagonally across the inner face of cap 56b along the rib 102 of pawl 71b. Channel 107 is broader than rib 102 to enable limited rotation of pawl 71b without interference from the cap.

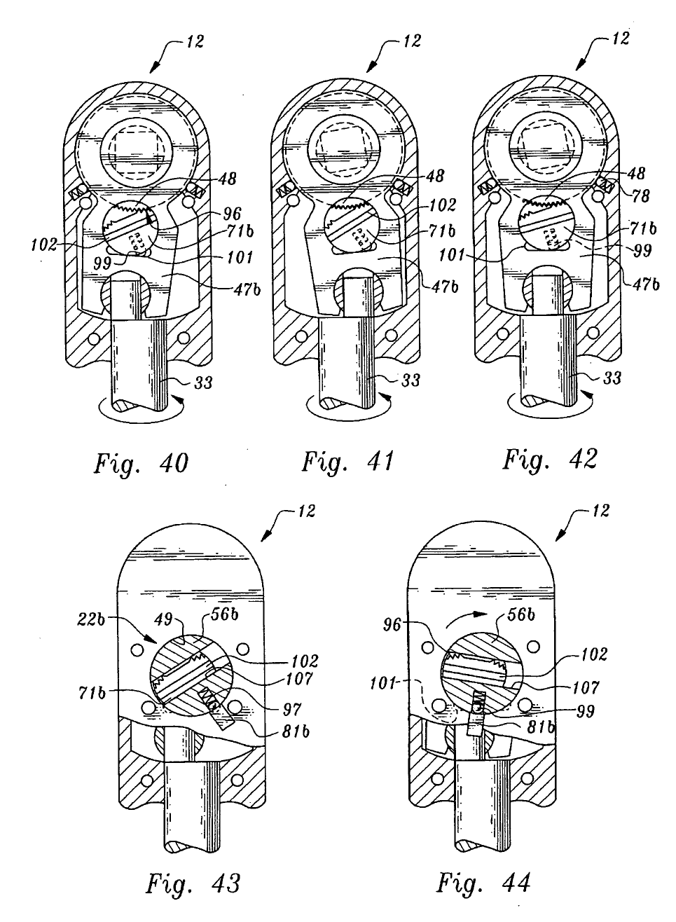

FIG. 40 depicts the above described components of the third embodiment at the start of a power stroke. One of the sets of pawl teeth 96 engages the ratchet gear 48 and turns the gear as the ratchet lever 47b is pivoted by turning of crankshaft 33 in the previously described manner. Detent 99 is situated at one end of slot 101 and prevents rotation of the pawl 71b relative to chamber 93 at that stage. FIG. 41 depicts the components at the end of the power stroke at which time the ratchet lever 47b begins its opposite pivoting movement or return stroke. FIG. 42 depicts the components during the return stroke of the lever 47b. Pawl 71b can rotate out of engagement with ratchet gear 48 at this stage as detent 99 can travel along slot 101 to accommodate to the pawl rotation. The detents 78 which act against the ratchet gear 48 inhibit any turning of the ratchet gear 48 at this stage. Thus repeated oscillation of lever 47b causes a repetitive incremental turning of ratchet gear 48 in s single direction

FIG. 43 depicts the position of the directional control 22b during the power stroke described above. At the beginning of the power stroke, the bar 102 of pawl 71b is aligned with the channel 107 of the directional control 22b. Channel 107 is sufficiently broad that it does not interfere with the small pivoting movements of bar 102 that are required during the power strokes and return strokes. FIG. 44 depicts the structure of FIG. 43 at a time when the operator is manually pivoting lever 81b to change the direction of rotation of the output of the wrench. The walls of channel 107 force turning of the pawl bar 102 and thus the pawl 71b to travel the pawl detent ball 99 towards the opposite end of slot 101. The initial part of this travel causes compression of pawl detent spring 97. Force exerted by the compressed spring 97 then aids in turning the pawl 71b during the final part of this travel. The turning of the pawl 71b causes the other set of pawl teeth 96 to engage the ratchet gear 48. Operation then proceeds as described above except that the ratchet gear is turned in an opposite direction.

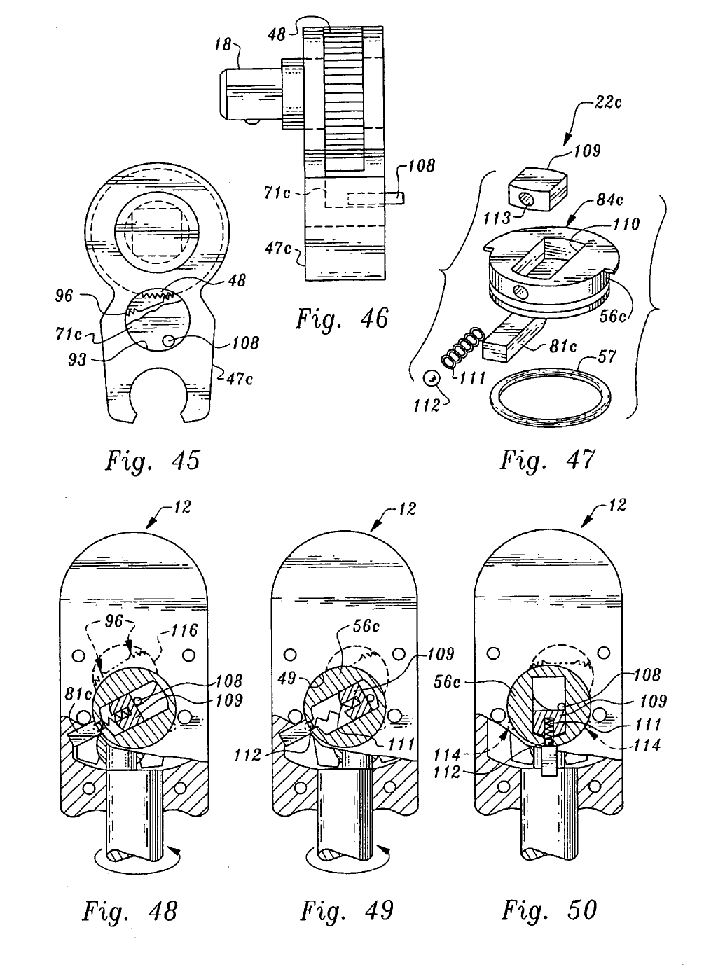

The third embodiment described above with reference to FIGS. 31 to 34 has a cylindrical pivoting pawl 71b with a spring 97 and detent ball 99 that urge the pawl towards a selected one of two alternate angular positions in order to determine the direction of rotation of the ratchet gear 48. The spring force may be applied to the pawl in a different manner as in the fourth embodiment of the invention shown in FIGS. 45 to 50. Referring initially to FIGS. 45 and 46, the cylindrical pivoting pawl 71c may be similar to the pawl of the third embodiment except that it has no diagonally directed bar and instead has a pin 108 which protrudes out of the ratchet lever chamber 93 that contains the pawl. As in the third embodiment, pawl 71c has two spaced apart sets of teeth 96 and the pawl is turnable between two different angular orientations at each of which a different one of the sets of teeth is positioned to engage the ratchet gear 48 during the power strokes of the ratchet lever 47c.

Referring to FIG. 47, the directional control 22c of the fourth embodiment has a circular cap 56c seating an annular seal 57c and having a radially extending shift lever 81c and a retainer lip 84c which are similar to the corresponding components of the previously described embodiment. A plunger 109 is slidable along a rectangular guide slot 110 which extends diagonally within cap 56c at the underside of the cap 56c. A compression spring 111 extends from a detent ball 112 at the periphery of cap 56c into a bore 113 in plunger 109.

Referring jointly to FIGS. 48, 49 and 50, cap 56c seats in the previously described manner in the circular opening 49 in the sealed head end housing 12 and is manually turnable to either of two different angular orientations to select the direction of rotation of the ratchet gear. Pockets 114 in the wall of opening 49 seat the detent ball 112 at each of these two orientations of the cap 56c. At either orientation, spring 111 pressure causes plunger 109 to exert a force against pawl pin 108 which rotates the pawl to bring one of the two sets of pawl teeth 96 into position for engaging ratchet gear 48 during power strokes of the ratchet lever in the manner previously described with reference to the third embodiment of the invention. During manual turning of the directional control 22c, as shown in FIG. 50 in particular, spring 111 compresses to allow travel of detent ball 112 from one of the pockets 114 to the other.

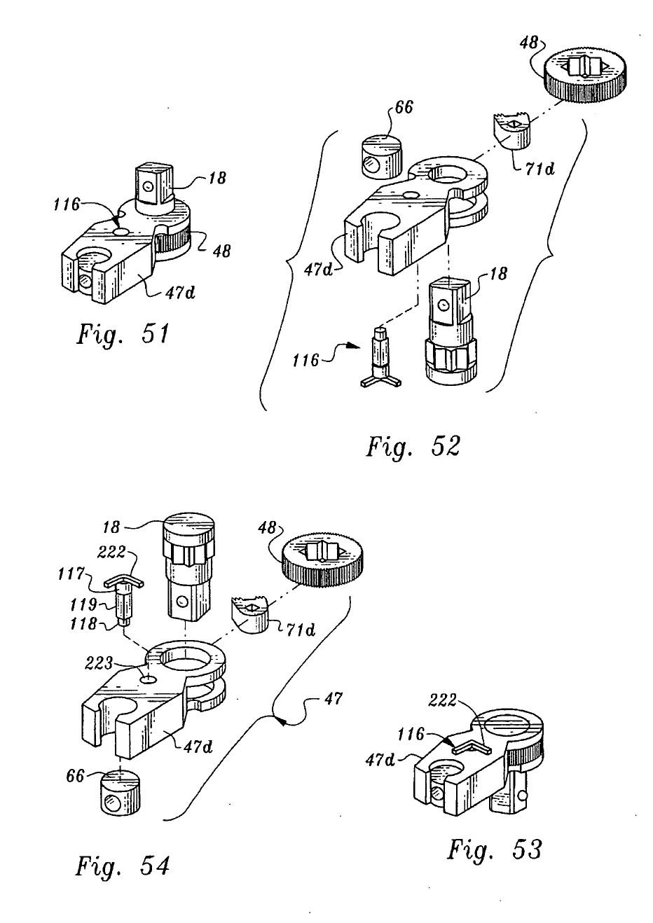

FIGS. 51 to 65 depict a fifth embodiment of the invention which is basically of the pivoting pawl type described above with reference to the third and fourth embodiment while having a modified directional control 22d and a modified form of pawl pin 116 for applying spring pressure to the pawl in a selected one of two different directions in order to rotate the ratchet gear 48 in a selected direction. Referring to FIGS. 51 to 54 in particular, ratchet lever 47d has a modified internal configuration, which will be hereinafter described, to accommodate to the differing pawl pin 116. Ratchet gear 48, square drive 18 and other components may be similar to those previously described.

The pawl pin 116 has front and back cylindrical bearing surfaces 117 and 118 respectively separated by a center section 119 of square cross section which extends through a conforming square opening 221 in pawl 71d. Opposite arms of an angled bar 222 extend laterally from the front end of pawl 71d to receive spring pressure as will hereinafter be described.

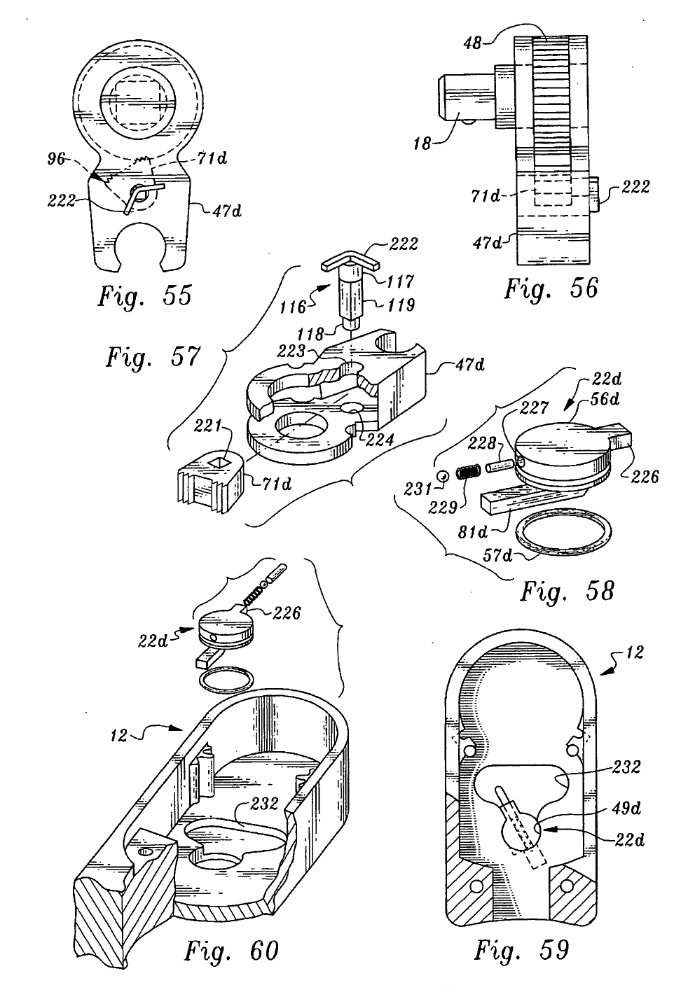

Referring to FIGS. 55, 56 and 57 in conjunction, bearing surfaces 117 and 118 of pawl pin 116 seat in conforming openings 223 and 224 in ratchet lever 47d. This positions the angled bar 222 of pawl pin 116 adjacent to the front surface of ratchet lever 47d and positions pawl 71d for engaging and disengaging ratchet gear 48 in the previously described manner as ratchet lever 47d is oscillated.

Referring jointly to FIGS. 58 to 61, the directional control 22d of the fifth embodiment has an arm 226 which extends radially from the cylindrical cap 56d. A bore 227 extends diagonally through cap 56d including arm 226. A slidable rod 228 is disposed in the bore and extends out of arm 226. A compression spring 229 in bore 227 urges rod 228 towards arm 226 and reacts against a detent ball 231 situated at the end of the bore that is opposite from arm 226.

Directional control 22d and an annular seal 57d are fitted into a conforming opening 49d in the front wall of head end housing 12 in the previously described manner. Arm 226 and rod 228 fit into a recess 232, formed in the inside surface of the front wall of the housing 12, which enables the rod to bear against the previously described angled bar 222 of pawl pin 116. One of two spaced apart pockets 233 in the wall of opening 49d seats detent ball 23 when directional control 22d is turned to either of its two settings. This resists turning of the directional control 22d by reactive forces produced by the pawl mechanism

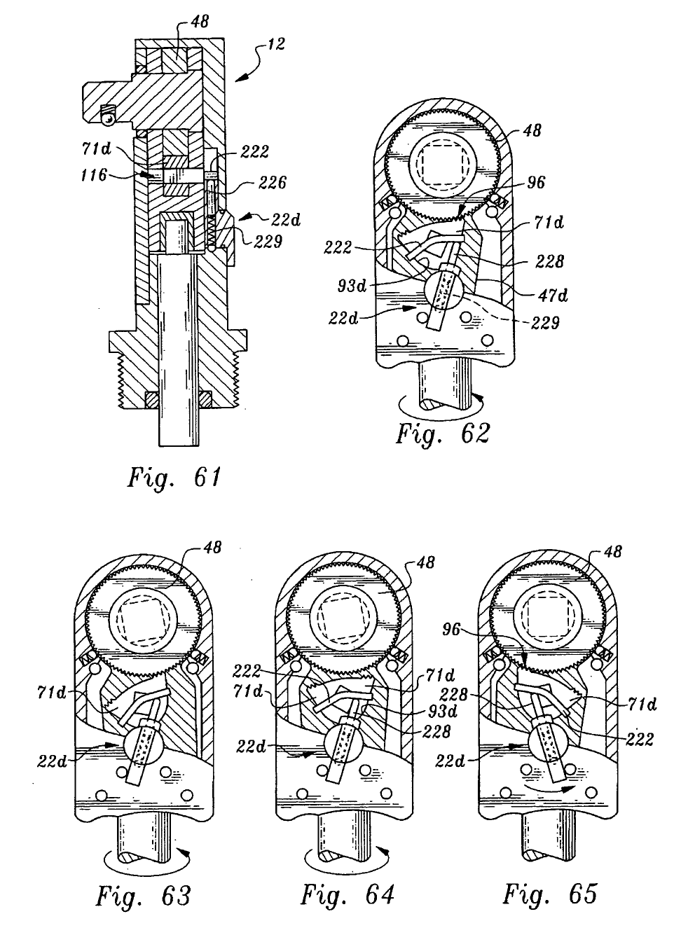

FIGS. 62 to 65 show the pawl and ratchet and directional control components of the fifth embodiment at successive stages of operation. FIG. 62 depicts the components at the beginning of a power stroke with directional control 22d turned to the setting which causes counterclockwise rotation of ratchet gear 48 and square drive 18. A first set of the pawl teeth 96 engages ratchet gear 48 during the power stroke to cause an increment of rotation of the gear as ratchet lever 47 is pivoted in the previously described manner. The contour of the opening 93d in which pawl 71d is situated keeps the pawl from turning out of engagement with gear 48 at this time. FIG. 63 depicts the same mechanism at the end of the power stroke. Rod 228 and spring 229 continue to apply pressure to bar 222 of the pawl pin 116 at this time but the contour of opening 93d allows pawl 71d to turn out of engagement with ratchet gear 48 during the subsequent return movement of ratchet lever 47d as shown in FIG. 64. FIG. 65 depicts the mechanism after the operator has turned directional control 22d to its alternate setting. Pressure from rod 228 and spring 229 now acts to bring the other set of pawl teeth 96 into position for engagement with the ratchet gear 48. Continued oscillation of the ratchet lever 47d then turns ratchet gear 48 in an opposite direction.

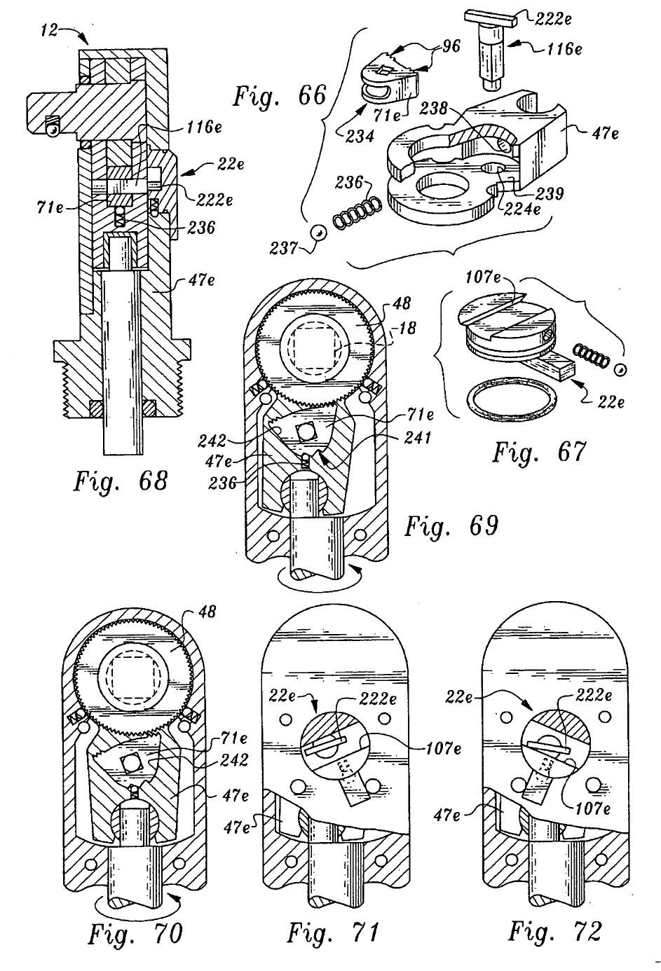

FIGS. 66 to 72 depict a sixth embodiment of the invention having a pivoting pawl 71e that is compatible with the sealed head end housing 12. The sixth embodiment may be similar to the fifth embodiment as described above except that the pawl 71e, pawl pin 116e and ratchet lever 47e have modified configurations. In particular pawl 71e has a recess 234 which extends into the region of the pawl that is opposite from the two sets of pawl teeth 96. The bar 222e which extends across the top of pawl pin 116e is straight instead of being angled as in the previous instance. A compression spring 236 and a detent ball 237 are disposed in a bore 238 in ratchet lever 47e that extends away from the center of the back wall of the pawl chamber 238 of the lever.

The directional control 22e of the sixth embodiment is of the previously described form having a linear channel 107e which extends diagonally across the underside of the cap 56e.

Referring to FIG. 69 and 70, the pawl recess 234 has two pockets 241, one of which seats detent ball 237 when pawl 71e is turned to produce counter-clockwise rotation of ratchet gear 48 and the other of which seats the ball when the pawl is pivoted to its alternate setting. Under either condition, spring 236 and ball 237 exert pressure on the pawl 71e which urges the pawl towards engagement with the ratchet gear 48.

FIG. 69 depicts the mechanism at the beginning of a power stroke of ratchet lever 47e. The adjacent back wall 242 of pawl chamber 238 forces pawl 71e to turn with the lever 47e and thereby turn the ratchet gear 48. As shown in FIG. 70, pawl 71e is free to turn slightly in a reverse direction, to disengage from gear 48, during the return stroke of the lever 47e.

FIG. 71 depicts directional control 22e during the mode of operation described above. Channel 107e of the directional control 22e is sufficiently broad that it does not interfere with the small oscillation of pawl pin bar 222e that occurs as the ratchet lever 47e oscillates. When the operator turns the directional control 22e to its alternate setting, as shown in FIG. 72, the walls of channel 107e force turning of bar 222e. This shifts the pawl to its alternate position and reverses the rotation of ratchet gear 48.

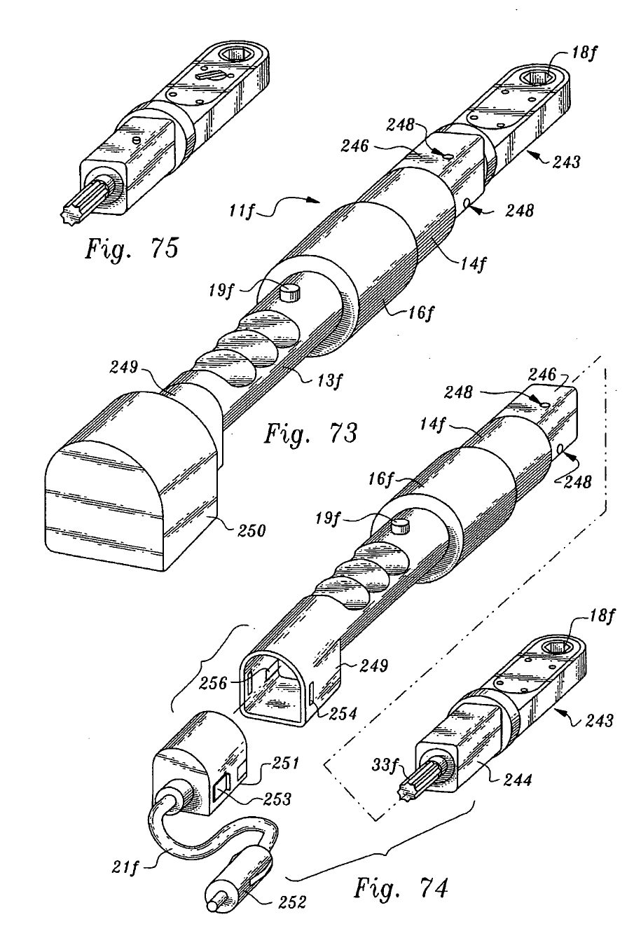

Referring to FIGS. 73 to 75, the wrench 11f may be designed to enable interchanging of one type of head end assembly 243 with a head end assembly of a different type. For example, the previously described head end assemblies have output elements of the square drive form on which separate sockets can be fitted. Replaceable head end assembly 243 of this example is of the box end type which has an output element 18f that is formed as a socket for directly engaging a threaded fastener. Except as hereinafter described, the pawl and other internal components of the replaceable head end assembly 243 and the directional control 22f of head end assembly 243 may be of any of the previously described forms.

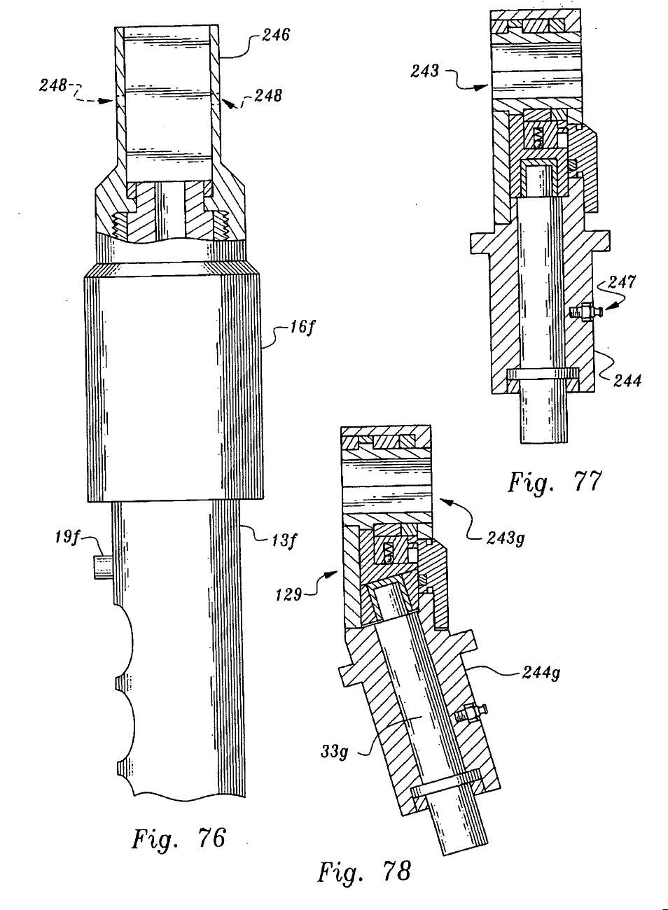

To enable interchanging, the replaceable head assemblies 243 have an adapter 244 of square cross section which is fitted into a conforming hollow receiver 246 that extends forward from the planetary gear housing 14f of the tool. Crankshaft 33f is elongated in order to extend through the nested adapter 244 and receiver 246 and to engage the planetary gearing in the previously described manner. Referring jointly to FIGS. 76 and 77, the nested adapter 244 and receiver 246 are latched together by a spring loaded plunger 247 which protrudes from a side of adapter 244. Plunger 247 can be depressed in order to insert the adapter 244 into receiver 246 and then snaps outward into an aperture 248 in the sidewall of the receiver when the adapter and receiver are fully nested. The plunger 247 can be depressed again in order to separate the adapter 244 and receiver 246 when a particular head assembly 243 is to be replaced with another.

Referring to FIG. 78, a replaceable head assembly 243g can be angled to enable operation in confined spaces where threaded fasteners may not be accessible with a straight head assembly. For this purpose, the adapter 244g can be angled relative to the head end housing 12g and the components within the housing without interfering with operation of the components in the previously described manner.

Referring to FIG. 74, 76 and FIG. 78 in conjunction, versatility of the angled head end assembly 243g can be enhanced by providing plunger engaging apertures 248 in more than one wall of the adapter receiver 246. In this example each of the four walls of the receiver 246 has an aperture 248 for seating the plunger 247 of the adapter 244. The head end assembly 243g can then extend from the handle at any selected one of four different angles depending on which is appropriate for a particular work site.

Referring to FIGS. 73 and 74 in particular, the powered ratchet wrench 11f of this example has a receptacle 249 at the end of the handle 13 that is shaped to receive and seat a battery 250 as shown in FIG. 73. Alternately, as shown in FIG. 74, the battery may be replaced with an electrical cord 21f having a plug 251 shaped to seat in receptacle 249. Cord 21f may connect with any suitable external power source. In this example the end of cord 21f has an adapter 252 of the known kind that can be plugged into the cigarette lighter socket of an automobile. In either case, spring clips 253 on the plug or battery snap engage in slots 254 in the wall of receptacle 249. Contacts 256 in the receptacle provide for electrical connection of switch 19f to the power source.

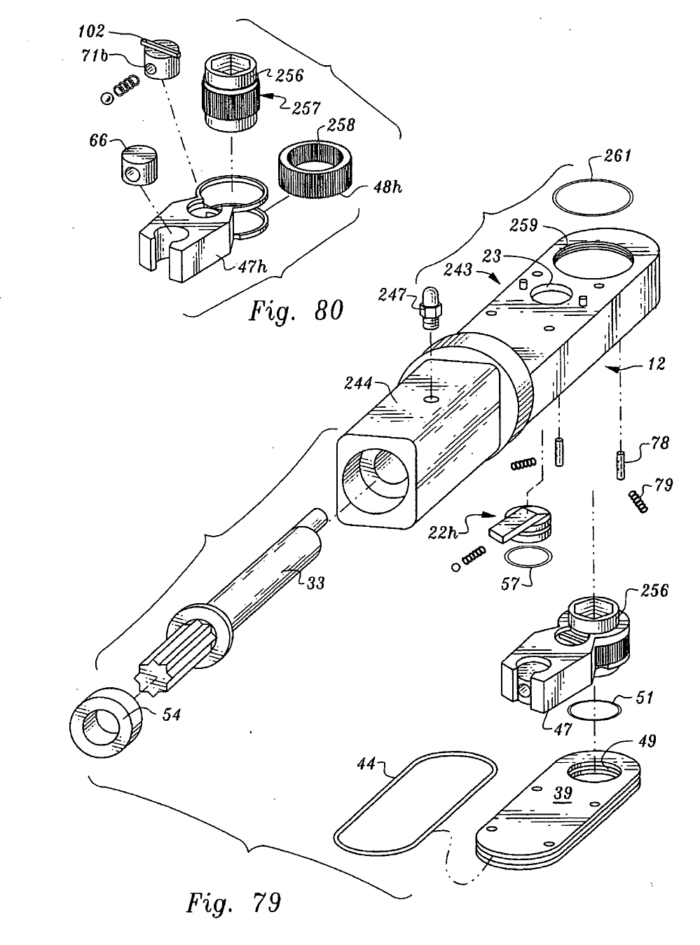

FIGS. 79, 80 and 81 illustrate a suitable internal construction for a head end assembly 243 in which the output member is a box end socket 256 of the type discussed above. The cylindrical box end socket 256 is seated in the head end of the ratchet lever 47h in coaxial relationship with ratchet gear 48h and has external splines 257 which engage internal splines 258 of the ratchet gear. The central portion of socket 256 at which the external splines 257 are located is a band of greater diameter than the end regions of the socket thereby enabling retention of the socket between the previously described ring portions 59 of the ratchet lever. The pawl driving mechanism within head end assembly 243 may be similar to the corresponding components of any of the previously described embodiments of the invention.

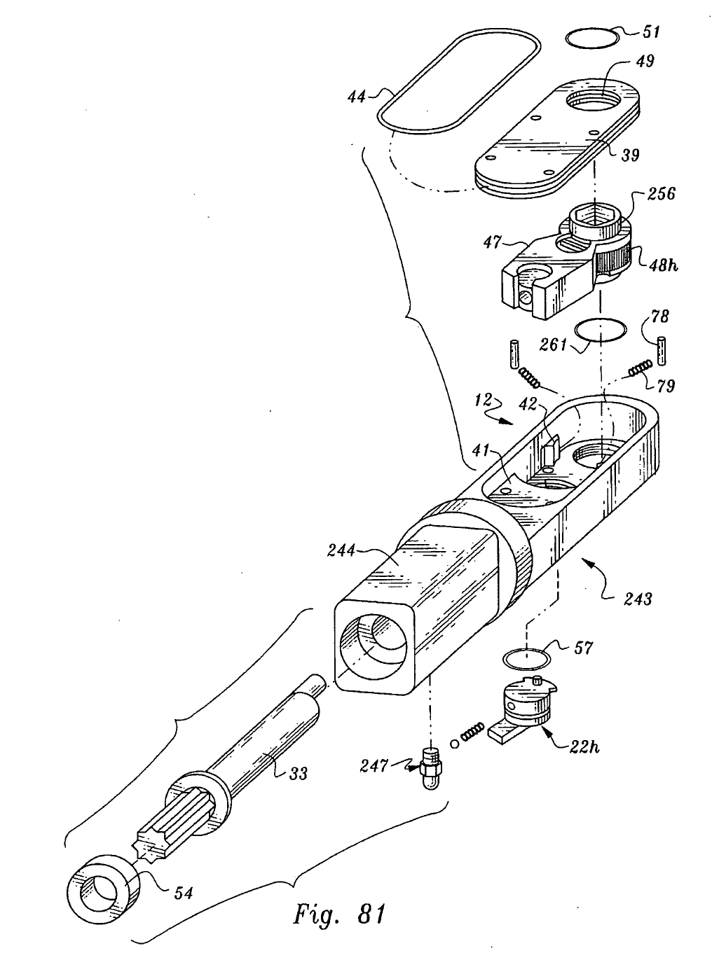

As the head end assembly 243 of this example is of the replaceable type, it is provided with an adapter 244 of the previously described form which includes a laterally protruding spring loaded plunger 247 for engaging the adapter with the other components of the tool as previously described. As best seen in FIG. 81 in particular, ratchet lever 47 and box end socket 256 are retained in place by a cover plate 39 which seats against shelves 41 and 42 in the head end housing 12 in the previously described manner. The housing 12 contains seals 44, 51, 54 and 57 at the previously described locations to prevent entry of foreign material and to retain lubricant. The front surface of head end housing 12 of this example differs from the housings of the previously described embodiments in that it has an additional circular opening 259 into which the box end socket 256 extends in order to expose the socket at both the front and the back of the tool. Another circular seal 261 is seated in opening 259.

This particular example of the invention has a pawl of the type previously described with reference to the third embodiment of the invention as shown in FIGS. 31 to 34. Thus the pawl 71b has a diagonally extending bar 102 which is selectively turned between two angular orientations in order to select the direction of rotation of the output member of the wrench. Referring again to FIGS. 79 to 81, the directional control 22h of this example which enables manual turning of the bar 102 from outside of the sealed head end housing 12 has a construction that differs from the corresponding component of the third embodiment.

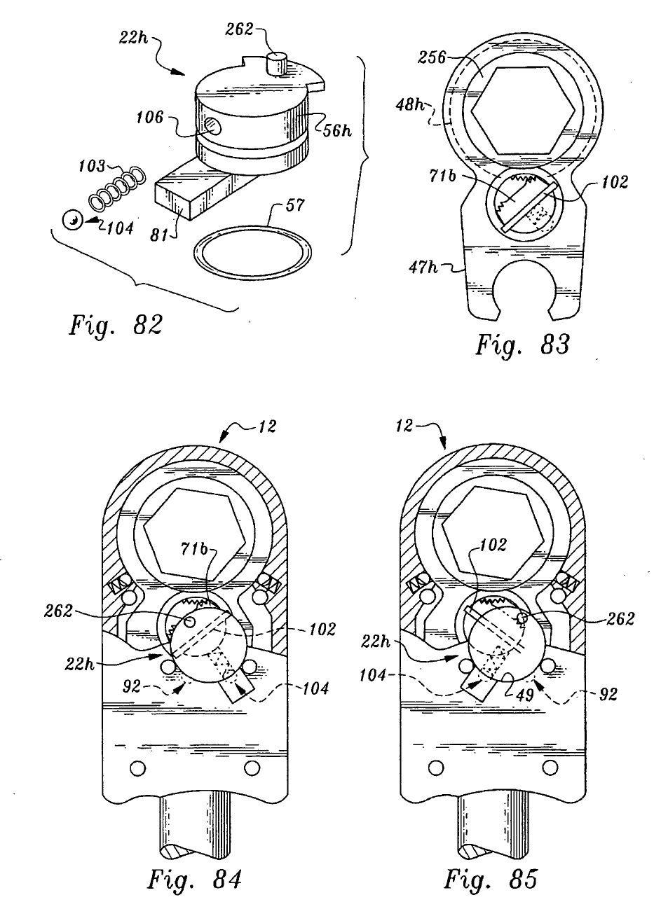

In particular, with reference to FIGS. 82 to 85 in conjunction, the cylindrical cap 56h of directional control 22h is similar to that of the previously described embodiment except that it has a pin 262 which protrudes from the underside of the cap to interact with the bar 102 of pawl 71b. As in the previous instance, cap 56h is encircled by a seal 57, has a radially extending lever 81 for facilitating manual turning of the cap and a compression spring 103 and detent ball 104 are disposed in a radial bore 106 in the cap. Pockets 92, shown in FIGS. 84 and 85, seat the detent ball 104 when the cap 56h is turned to either of its angular orientations. Turning of the cap 56h from one of these orientations to the other causes pin 262 to turn bar 102 sufficiently to reverse the direction of rotation of the ratchet gear 48h in the previously described manner.

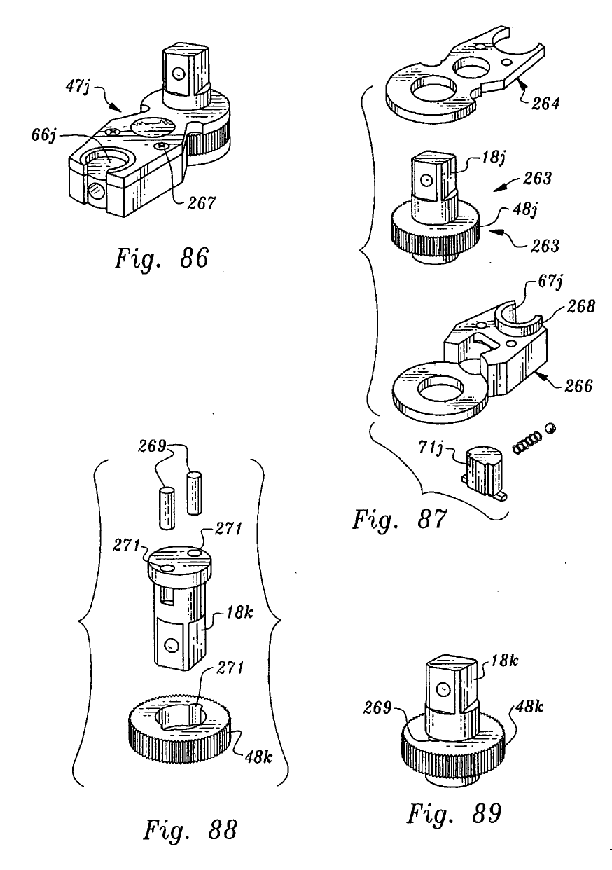

Specific examples of ratchet gear driving mechanism have been described above that can be contained in a sealed head end housing. It should be recognized that variations of the design of various components are possible. For example, FIGS. 86 and 87 depict an alternate construction in which the ratchet gear 48j and the square drive 18j are a single integral output element 263. In order to assemble the integral output element 263 into the ratchet lever 47j, the ratchet lever is formed as a two piece component. The back portion 264 of the ratchet lever 47j which is situated behind the ratchet gear 48j is a removable plate that is secured to the front portion 266 of the ratchet gear by screws 267. The removable back portion 264 does not include the wall 268 of the cavity 67j in which coupler cylinder 66j oscillates. Wall 268 remains integral with front portion 266 of the ratchet lever 47j to provide an uninterrupted bearing surface for the coupler cylinder 66j. The two piece ratchet lever 47j may otherwise be similar to the corresponding component of previously described embodiments of the invention.

FIGS. 88 and 89 depict an alternate construction in which the ratchet gear 48k and square drive 18k are again separable components and are engaged with each other by a pair of pins 269 instead of by splines as in previously described embodiments. Pins 269 are disposed in bores 271 that are located to be partially in square drive 18k and patially in the ratchet gear 48k. Thus the pins 269 function as keys which force the ratchet gear 48k and square drive 18k to rotate together.

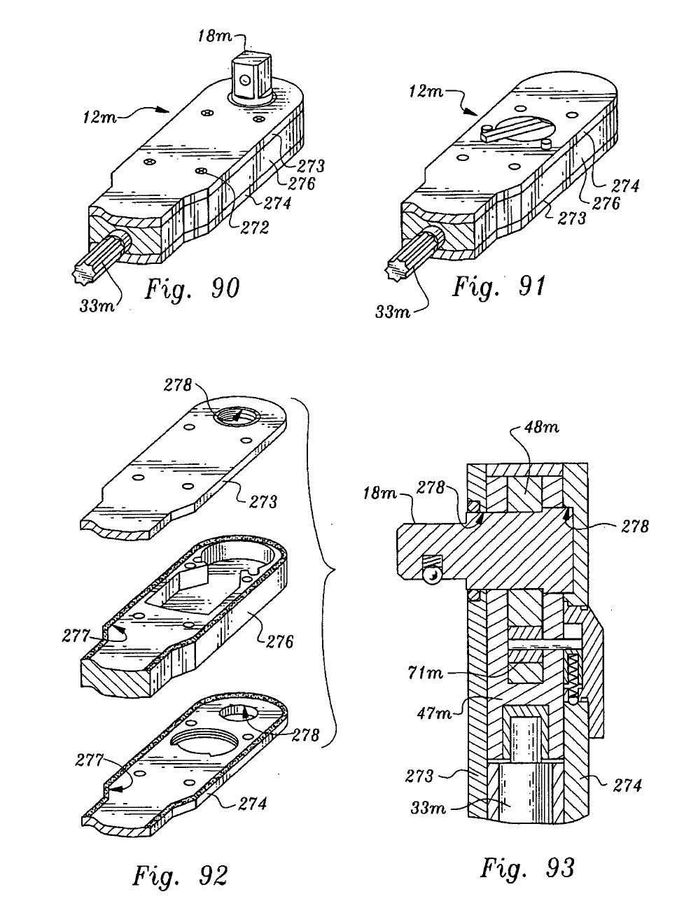

FIGS. 90 to 93 depict an alternative construction for the sealed head end housing 12m in which the housing has three separable component layers held together by screws 272. In particular, the portion of the housing which is behind the ratchet lever 47m is a separable back plate 273 and the portion of the housing which is in front of the lever is a separable front plate 274. Plates 273 and 274 seat against a center layer 276 and seals 277 are situated between the back and front plates and the center layer. Components such as the ratchet lever 47m, ratchet gear 48m, pawl 71m and crankshaft 33m are contained within the center layer 276 and may be similar to the corresponding components of any the previously described embodiments of the invention such as, in this particular example, the embodiment of FIG. 27 to FIG. 30.

An advantage of the three piece sealed head end housing 12m of FIGS. 90 to 93 is that the center layer 276 may be formed of a material that differs from the material that the front and back plates 273 and 274 are formed of which is typically steel. Although not apparent in the drawing, dimensional tolerances can be selected so that the curved surfaces 278 of front and back plates 273 and 274 that contact square drive 18m function as the bearing surfaces for the square drive. The center layer 276 of the housing can then be formed of a lighter and less wear resistant material such as a high impact plastic.

While the invention has been described with reference to certain particular embodiments for purposes of example, many other variations and modifications of the sealed powered ratchet wrench are possible and it is not intended to limit the scope of the invention except as defined by the following claims.

1. A motor driven ratchet wrench having a head end housing attached to a handle, a ratchet gear situated at a first opening in the head end housing and output means for applying torque to external threaded fasteners in response to rotation of the ratchet gear, the wrench further having a crankshaft extending through a second opening in the head end housing and having pawl and pawl driver means within the head end housing for rotating said ratchet gear in repetitive increments in response to continuous rotation of said crankshaft, further comprising a plurality of seals including at least one seal disposed at each opening in the head end housing thereby blocking entry of external substances into the head end housing and thereby retaining lubricant in the head end housing.

2. The apparatus of claim 1 further including a manually operable direction control member disposed at a third opening in said head end housing and direction reversing means for selecting the angular direction of the incremental rotation of said ratchet gear in response to operation of said direction control member, said plurality of seals including at least one seal disposed at said third opening.

3. The apparatus of claim 1 wherein said head end housing forms a sealed chamber with one wall thereof being a removable cover plate, wherein said plurality of seals includes a seal disposed at a peripheral portion of the cover plate.

4. The apparatus of claim 1 further including a manually operable direction control member disposed at a third opening in said head end housing and direction reversing means for selecting the angular direction of the incremental rotation of said ratchet gear in response to turning of said direction control member, wherein said directional control member is manually turnable in an angular direction and is otherwise in a fixed position on said head end housing.

5. The apparatus of claim 4 wherein said pawl is slidable between two different locations to reverse the direction of rotation of said output means and wherein said direction reversing means causes sliding of said pawl between said two different locations in response to manual turning of said directional control member.

6. The apparatus of claim 5 wherein direction reversing means includes a spring positioned to urge said sliding pawl towards the selected one of said two different locations.

7. The apparatus of claim 4 wherein said pawl is pivotable between two different angular orientations to reverse the direction of rotation of said output means and wherein said direction reversing means causes pivoting of said pawl between said two different angular orientations in response to manual turning of said directional control member.

8. The apparatus of claim 7 wherein direction reversing means includes a spring positioned to urge said pivotable pawl towards the selected one of said two different angular orientations.

9. The apparatus of claim 1 wherein said head end housing including said output means and said ratchet gear and said crankshaft and said pawl and pawl driver means is detachable from said wrench and is replaceable with other head end housings.

10. The apparatus of claim 1 wherein said wrench has a receptacle configured for seating a removable battery in one mode of operation and for seating a terminal plug of an electrical cord in another mode of operation.

11. The apparatus of claim 1 wherein said head end housing is formed by a front plate and a back plate and a center layer, said ratchet gear and said crankshaft and said pawl and pawl driver means being contained within said center layer, further including a seal disposed between said front plate and said center layer and an additional seal disposed between said back plate and said center layer.
